(19) United States
(12) Patent Application Publication
(10) Pub. No.: US 2005/0218253 A1
(43) Pub. Date: Oct. 6, 2005

(54) Device and method for shredding materials

(76) Inventor: D. Donald Hess, Lancaster, PA (US)

Correspondence Address: MCNEES, WALLACE & NURICK LLC, 100 PINE STREET, P.O. BOX 1166, HARRISBURG, PA, 17108-1166, US

(21) Appl. No.: 10/812,821

(22) Filed: Mar. 30, 2004

(51) Int. Cl. B02C 18/16

(52) U.S. Cl. 241/236

(57) ABSTRACT

A shredding device for shredding a material includes a first blade and a second blade that is sufficiently adjacent to the first blade so that the first blade and the second blade overlap and intermesh. The first and second blades are rotatably associated with each other and are urged into rotational movement by a rotating means. A feeder controllably directs the material into the overlap region between the rotating first and second blades for producing shredded material segments, the segments measuring less than a predetermined dimension in any direction.

### FIELD OF THE INVENTION

The present invention is directed to a device and method for shredding materials, and more specifically to a device and method for shredding materials to produce shredded material segments measuring less than a predetermined dimension in any direction.

### BACKGROUND OF THE INVENTION

Shredders or shredding devices are employed in many office and industrial applications to reduce the size of a material for an intended purpose. Briefly, materials that can be shredded include paper, plastic, electronic scrap, pallets, metal, tires, concrete and construction waste. Materials are typically shredded to reduce its size for ease of handling, especially to improve transportability of the material, or, in the case of a shredder associated with a land fill, to permit more efficient storage of the material. Alternately, sufficiently shredding a material may permit the material to be recycled.

Typically, an industrial shredder comprises a series of spaced blades rotatably carried by a single shaft, or a pair of rotating spaced blades each rotatably carried by a shaft. The blades are located at the base of a chute. Material is placed in the chute, and shredding is effected by teeth that extend outwardly along the periphery of the rotating blades. These teeth pass through and typically remove sizeable, coarse chunks or segments of the material. The coarsely shredded material may be transported to a desirable location, such as a conveyor system, for collection and removal.

However, it may be advantageous to significantly reduce the size of shredded material segments. For example, in the case of residential construction, gypsum board is a common construction waste product that typically must be removed from the site once the residence has been constructed. Gypsum board, also referred to as drywall, typically consists of a layer of gypsum material that is surrounded on opposite sides by paper layers. Properly shredded, that is, reduced to pieces that do not exceed approximately one-half inch when measured in any direction, including the paper layers, the shredded gypsum and paper material segments may be spread onto the ground of the construction site and covered with topsoil. Not only does the gypsum material deposited in this fashion aid in seed emergence and help prevent soil erosion, but costs associated with its removal may be significantly reduced.

Therefore, there is a need for a shredder construction that produces shredded material segments of a predetermined size using existing spaced blade arrangements.

### SUMMARY OF THE INVENTION

The present invention relates to a shredding device including a feeder, and at least one first blade having a first cutting area. At least one second blade has a second cutting area and is rotatably disposed substantially parallel to the at least one first blade, the first cutting area of the at least one first blade overlapping at least a portion of the second cutting area of the at least one second blade. Means for rotating the at least one first blade and the at least one second blade, wherein rotation of the at least one first blade does not interfere with the rotation of the at least one second blade. The feeder is configured to controllably direct a material into the overlapping portion of the at least one first blade and the at least one second blade to produce shredded material segments, the segments measuring less than a predetermined size in any direction.

The present invention also relates to a method for shredding a material with a shredding device for producing shredded material segments, the shredding device including a feeder, at least one first blade, at least one second blade rotatably associated with the at least one first blade, the at least one first blade and the at least one second blade having an overlap. The method includes rotating the at least one first blade and the at least one second blade, directing the material into the overlap for producing shredded material segments, and forming a plurality of blade cutting surfaces having a negative hook angle of at least about 45 degrees on at least one of the at least one first blade or the at least one second blade so as to produce non-strip material segments measuring less than a predetermined size in any direction.

The present invention further relates to a shredding device including a feeder, a plurality of first blades, a plurality of second blades interposed between the plurality of first blades and rotatably associated with the plurality of first blades, the plurality of first blades and the plurality of second blades having an overlap and intermeshing, wherein at least one of the plurality of first blades and at least one of the plurality of second blades has a negative hook angle of at least about 45 degrees. Wherein upon the material being directed into the overlap, each of the plurality of first blades and the plurality of second blades cut through the entire thickness of the material and contain a protrusion past a surface of the material that is furthest from each of the at least one first blade and the at least one second blade. Means for rotating the at least one first blade and the at least one second blade wherein rotation of the at least one first blade does not interfere with the rotation of the at least one second blade. The feeder controllably directs a material into the overlap for producing non-strip shredded material segments, the segments measuring less than a predetermined size in any direction. A conveyor having a first end and a second end, the first end of the conveyor being disposed adjacent to the at least one first blade and the at least one second blade for transporting shredded material segments to a location away from the at least one first blade and the at least one second blade. An enclosure disposed adjacent the second end of the conveyor, the enclosure surrounding the location receiving the shredded material segments from the conveyor.

An advantage of the present invention is achieving shredded material segments of a predetermined size using existing spaced blade arrangements.

Another advantage of the present invention is producing material segments that can be distributed on-site, not transported to another location.

Another advantage of the present invention is that distribution of the shredded material on-site eliminates shipping costs associated with transportation to another location and landfill tipping fees, when the other location is a landfill. Of course, the present invention conserves landfill resources.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is an elevation view of a shredder of the present invention;

FIG. 2 is a plan view taken along line 2-2 of FIG. 1 of the shredder of the present invention;

FIG. 3 is an enlarged partial elevation view of a blade arrangement from a blade of the present invention;

FIG. 4 is a possible orientation and arrangement of the overlapping blades of the present invention;

FIG. 5 is another possible orientation and arrangement of the overlapping blades of the present invention;

FIG. 6 is still another possible orientation and arrangement of the overlapping blades of the present invention; and

FIG. 7 is yet another possible orientation and arrangement of the overlapping blades of the present invention.

### DETAILED DESCRIPTION OF THE INVENTION

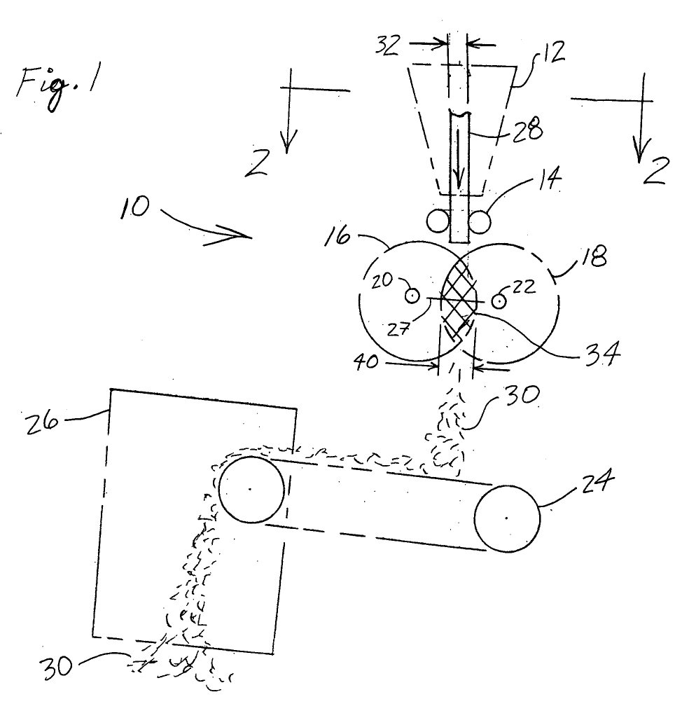

The shredder 10 of the present invention is shown in FIG. 1. A quantity of material 28 is placed in a chute 12, also referred to as a hopper, for guiding the material 28 between a feeder 14 which controllably feeds the material 28 into a first blade set 16 and a second blade set 18. The first and second blade sets 16, 18 each have a respective first cutting area and second cutting area for cutting the material 28. The first and second blade sets 16, 18 are rotatably associated with each other, having an overlap 34 of the respective first and second cutting areas, the first and second blade sets 16, 18 being urged into rotational movement by a driving means (not shown). Stated another way, the blades intermesh such that the rotational movement of one roller does not interfere with the rotational movement of the adjacent roller. Material 28 is controllably fed into the overlap 34 by the feeder 14 for shredding the material 28, producing shredded material segments 30. The shredded material segments 30 are then transported away from the first and second blade sets 16, 18 by a conveyor 24 for centralized collection of material 28. An enclosure 26 adjacent the end of the conveyor 24 that is opposite the first and second blade sets 16, 18 provides a substantially enclosed region extending from over the end of the conveyor 24 to the ground to promote settling of smaller particles associated with the shredded material segments 30.

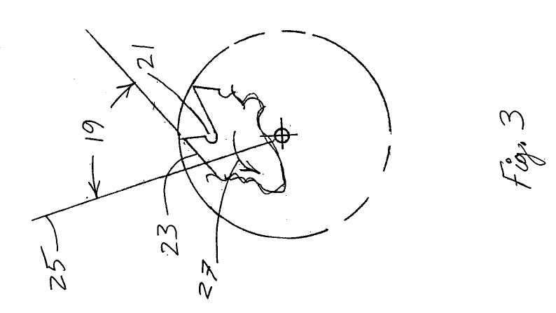

The feeder 14 preferably includes a pair of opposed rollers, but may include multiple pairs of rollers, that both aligns and controllably feeds the material 28 received from the chute 12 to the rollers that include first and second blade sets 16, 18. That is, if multiple pieces of material 28 are fed into the chute 12, the feeder 14 only permits a maximum thickness of the material 28, typically corresponding to the thickness 32 of a single piece of material 28, to be fed into the first and second blade sets 16, 18 for reasons to be further discussed below. However, the feeder 14 may be configured to work with material 28 that is of uneven thickness or even if the material 28 is coarsely shredded, interconnected segments of material 28. In other words, material 28 of non-uniform thickness and even non-rigid consistency may be shredded by the shredder 10 of the present invention so long as the feeder 14 is configured to accept the segments of material 30, up to a predetermined maximum thickness. The feeder 14 then controllably directs the segments of material 30 into the overlap 34 of the first and second blade sets 16, 18. The feed rate of the feeder 14 is related to the rotational speed of the first and second blade sets 16, 18, which relationship being dependent upon the type and thickness of material being shredded. It is understood that the shredder 10 may operate at variable speeds, permitting varying the feed rate of material 28 into the chute 12, so long as a relationship between the feed rate of material 28 by the feeder 14 and the rotational speed of the first and second blade sets 16, 18 is maintained. The term relationship as used herein refers to a minimum ratio between the feed rate of the feeder 14 and the rotational speed of the first and second blade sets 16, 18. That is, while it may be preferred that the first and second blade sets 16, 18 rotate in opposite directions at substantially the same speed (FIG. 4), neither constraint is necessary to produce favorable results. Also, while it is preferred that rollers that include blade sets 16, 18 be of the same diameter and that first and second blade sets 16, 18 be of the same size, such constrains also are not necessary.

Preferably, to maintain the relationship between the feeder 14 and the first and second blade sets 16, 18, the driving means is drivingly connected to the feeder 14 and the first and second blade sets 16, 18 by pulleys, gears or similar mechanical means. Alternately, the feeder 14 and the first and second blade sets 16, 18 may be rotatably driven by independent driving means, incorporating sensors monitored by microprocessors, so long as the relationship is maintained. The driving means may include a motor or engine that utilizes electrical, fossil fuel, hydraulic or any other source of power that is known in the art.

While the preferred embodiment shows the chute 12 receiving the material 28 in a substantially vertical orientation, it is appreciated that so long as the feeder 14 and the first and second blade sets 16, 18 are properly aligned and configured, the orientation of the chute 12 may deviate significantly from a vertical orientation. This deviation may include an embodiment in which the chute 12 is positioned below the feeder 14 and the first and second blade sets 16, 18.

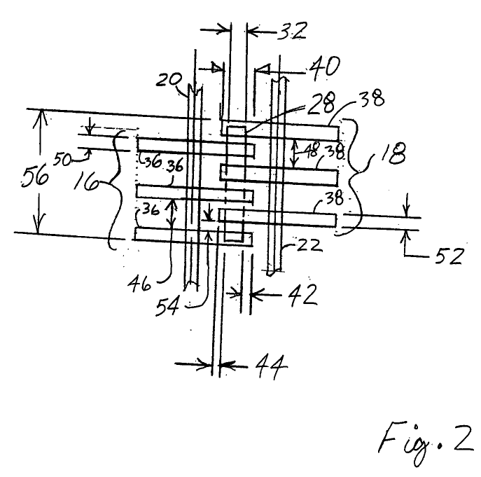

Referring to FIGS. 1 and 2, the first blade set 16 is rotatably carried by axis 20 of a first roller and the second blade set 18 is rotatably carried by axis 22 of a second roller to shred the material 28 controllably received from the feeder 14. The first and second blade sets 16, 18 are configured to define the overlap 34 of the respective first and second cutting areas as shown by the cross-hatched area in FIG. 1. Preferably, the first blade set 16 includes a plurality of substantially uniformly sized and spaced first blades 36, and the second blade set 18 includes a plurality of substantially uniformly sized and spaced second blades 38. The substantially parallel axes 20, 22 are sufficiently adjacent so that the first blades 36 of the first blade set 16 and the second blades 38 and their respective cutting areas of the second blade set 38 are alternately arranged substantially parallel with each other so as not to interfere as the rollers rotate. A maximum overlap 40 between the first blades 36 and the second blades 38 is measured along a line 27 that is substantially perpendicular to axes 20, 22 and coincident with the centers of axes 20, 22. Preferably, the blades 36 of the first blade set 16 and the blades 38 of the second blade set 18 are sized and spaced substantially similar with each other. That is, a thickness 50 of the first blade 36 is substantially similar to a thickness 52 of the second blade 38 and a distance 46 between adjacent first blades 36 is substantially similar to a distance 48 between adjacent second blades 38. Under this preferred arrangement, a controlled space 54 between facing surfaces of adjacent first and second blades 36, 38 is achieved, which may be calculated by taking the distance 46 between facing surfaces of adjacent first blades 36, subtracting the thickness 52 of the second blade 38 interposed between the adjacent first blades 36, and dividing that number by two. Alternately, space 54 may be calculated by taking the distance 48 between facing surfaces of adjacent second blades 38, subtracting the thickness 50 of the first blade 36 interposed between the adjacent second blades 38, and dividing that number by two.

The blade arrangement of the present invention includes a blade density, which is defined herein as the sum of the blade thicknesses 50, 52 of the first and second blades 36, 38 divided by the combined blade width 56, which is defined herein as the greatest distance between the surfaces of the first and the second blades 36, 38. Thus, if the sum of blade thicknesses 50, 52 is 12 inches and the combined blade width 56 is 24 inches, the blade density is 0.50, or may alternatively be expressed as 50 percent. Stated another way for the present example, shredding a piece of material that is 24 inches wide that is aligned to coincide with the combined blade width 56, will be subjected to a blade having an effective cutting width of 12 inches. That is, as the material is shredded by the blades 36, 38, 12 inches of the 24 inch width of the material is subjected to cutting surfaces of the blades 36, 38. Similarly, if the sum of blade thicknesses 50, 52 is 18 inches and the combined blade width 56 is 24 inches, the blade density is 0.75, or may alternatively be expressed as 75 percent. Stated another way for the present example, shredding a piece of material that is 24 inches wide that is aligned to coincide with the combined blade width 56, will be subjected to a blade having an effective cutting width of 18 inches. However, it is to be understood that the combined width 56 is not limited to 24 inches, and could be sized to accommodate any width. The size of the material segments produced appears to depend upon the type of material being shredded, the relationship between the feed rate of the material into the shredder and the rotational speed(s) of the blades, and the blade density, for a given blade profile. Although the embodiment of the first and second blades 36, 38 does not disclose a blade tip, which may be comprised of carbide material or other hardened material for providing extended blade life, blade tips are contemplated herein. In other words, for simplicity, the blades shown in FIG. 2 lack a tip and also lack angling the blades out of or into the surface of the blades, so that the kerf, which is the thickness of the cut produced by the blade, and the blade thickness are substantially the same. However, it is an easy matter to incorporate blade tips into the calculation of blade density, including measuring the distance between the surfaces of the blade tips, or the total kerf in case the blades are angled, instead of the blade thicknesses 50, 52, and similarly accounting for these features when measuring the combined blade width 56, as previously discussed. For example, a blade density for shredding gypsum board for a wide range of feed rates is from about 0.50 to about 0.65.

An important aspect of the shredder 10 is related to the feeder 14 feeding the material 28 into the overlap 34. In a preferred arrangement, the material 28 having a thickness of 32, is fed into the middle of the overlap 34. In the instance where the material is drywall, the thickness typically ranges from about ¼ of an inch to about ¾ of an inch, although the shredder 10 may be used for material thicknesses up to about 2 inches. In the preferred arrangement, the first blade 36 not only cuts through the entire thickness of the material 28, but contains a protrusion 42 which extends past the surface of the material 28 that is furthest from the shaft 20. Similarly, the second blade 38 not only cuts through the entire thickness of the material 28, but contains a protrusion 44 which extends past the surface of the material 28 that is furthest from the shaft 22. When the material 28 is passed through the center of the overlap, the protrusion 42 preferably equals the protrusion 44. However, it is realized by one having skill in the art that the material 28 is not required to be fed into the exact center of the overlap 34, so long as each of the first and second blades 36, 38 have some amount of protrusion 42, 44, respectively, through the material 28. Due to the protrusions 42, 44, preferably, each of the first and second blades 36, 38 cut through the material 28 in the direction the material 28 is fed by the feeder 14 into the first and second blade sets 16, 18 which cut the material 28 into a plurality of narrow strips or material segments 30. However, while these lengthwise or longitudinal cuts in the material 28 may produce narrow strips having widths 54 as previously discussed, it is frequently additionally desirable to also significantly reduce the strip lengths of the material segments 30. This length reduction must be made without requiring a further cross cutting operation or apparatus, such as an additional set of blades transverse to the first and second blade sets 16, 18, which adds complexity and expense to the shredder.

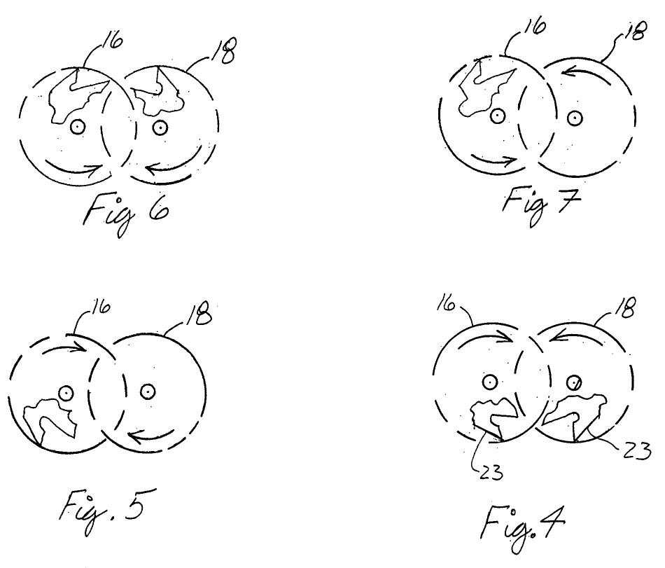

Referring to FIGS. 3-7, a negative hook angle 19 is incorporated into the first and the second blades 36, 38. The hook angle refers to the amount of “lean” exhibited by the blade tooth and is measured by the intersection of two lines. The first line corresponds to the edge of the tooth cutting surface 23, and the second line is a radial line 25 which extends outwardly from the center of the blade, or arbor. The negative orientation is due to the cutting tool surface 23 being directed opposite the direction of rotational travel of the tooth. For example, in FIG. 3, for a rotational direction 27, hook angle 19 is negative. Conventionally, small negative angles, typically measuring five degrees or less, are used in power saws to prevent self-feeding of materials into the blade. However, the magnitude of the negative angle of the blades of the present invention is in the range of from about 45 degrees to about 80 degrees with 60 degrees being preferred. These substantially increased magnitudes of negative hook angles 19 impart a shredding action to the material 28. Referring to FIGS. 4-7, which are possible blade set 16, 18 orientations usable in FIG. 1, although FIG. 4 may be preferred, all orientations may provide favorable results. For example, drywall can be shredded to produce segments measuring about ½ inch by ½ inch in size or less. Similarly, although it is also preferred that each of blade sets 16, 18 are configured to operate with the negative hook angles 19, other arrangements may also be successfully employed. For example, the negative hook angles 19 may successfully be employed on only one of the first blade set 16 or the second blade set 18, or alternating blades 36, 38 of each of the blade sets 16, 18. Therefore, so long as at least one of the blade sets 16, 18, or alternating blades 36, 38 of each of the blade sets 16, 18 utilizes the negative hook angle 19 of significant magnitude, the other blade set or remaining blades of the blade sets may use different hook angles 19 of reduced negative magnitude, or even positive hook angles, to achieve favorable results. In addition to maintaining the relationship between feeder feed rate and blade rotation speeds, by employing a proper combination of blades configured with negative hook angles 19, the strip lengths of material segments 30 can be effectively controlled.

To prevent clogging of the blades sets 16, 18 during operation with shredded material, a gullet 21 is disposed adjacent the base of each blade cutting surface 23 as shown in FIG. 3. The gullet typically defines an open geometric profile that is preferably between about 80 and 90 of the length of the entire cutting surface. However, depending upon the material being shredded and the desired feed rate, these percentages can vary significantly.

Referring back to FIG. 1, once the material 28 has been subjected to and shredded by the blade sets 16, 18, the shredded material segments 30 are deposited preferably by force of gravity onto the surface of conveyor 24. The conveyor 24 then transports the shredded material segments 30 some distance away from the blade sets 16, 18 and similarly deposits the shredded material segments 30 in a concentrated location, such as on the ground, for subsequent use or disposition. As the shredded material segments 30 leave the conveyor 24, an enclosure 26 which surrounds the end of the conveyor 24 opposite the blade sets 16, 18 permits the smaller, pulverized shredded material segments 30 to settle onto the ground or collection surface. That is, the enclosure 26 minimizes the amount of airborne material particles produced during the shredding process from release into the air and possible inhalation by construction workers. The enclosure 26 preferably includes a pliable “curtain” that extends downwards from the conveyor 24, surrounding the collection surface onto which the material segments 30 are deposited from the conveyor 24. Alternately, the enclosure 26 may be comprised of a plurality of interposed flaps comprised of a resilient material, such as a transparent polymer, that are easily manually separated to provide unrestricted access to the shredded material segments 30, but otherwise hangs substantially vertically in contact with adjacent flaps to provide a sealed region to minimize the release of airborne material particles.

In operation, referring to FIGS. 1-7, once the driving device of the shredder 10 is actuated and the feeder 14 and the first blade set 16 and the second blade 18 are brought up to the desired operating rotational speed with respect to the rate of feeder 14, material 28 is fed into the chute 12. The feeder 14 controllably feeds material 28 received from the chute 12 toward the overlap 34 defined by the first blade set 16 and the second blade set 18. As the material 28 is directed into the overlap 34, the rotating blades 36 of the first blade set 16 and the rotating blades 38 of the second blade set 18 each protrude through the entire thickness 32 of the material 28, cutting the material 28 into a plurality of narrow strips. However, due to at least one of either of the first blade set 16 or the second blade set 18 having significant negative hook angles 19, imparting an additional tearing action to the material 28 being shredded in addition to cutting the material 28 substantially in the feed direction from the feeder 14, shredded material segments 30 of significantly reduced dimensions are produced, which segments measuring less than a predetermined size in any direction. Upon the material 28 being reduced to material segments 30 by the combined cutting and tearing actions of the first blade set 16 and the second blade set 18, the material segments 30 are then deposited onto the conveyor 24. Once the material segments 30 reach the opposite end of the conveyor 24, the material segments 30 are deposited onto the collection surface for ease of collection, the material segments 30 being surrounded by the enclosure 26 to minimize the amount of released airborne particles produced by the shredding process.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A shredding device comprising:
a feeder;
at least one first blade having a first cutting area;
at least one second blade having a second cutting area and being rotatably disposed substantially parallel to the at least one first blade, the first cutting area of the at least one first blade overlapping at least a portion of the second cutting area of the at least one second blade;
means for rotating the at least one first blade and the at least one second blade, wherein rotation of the at least one first blade does not interfere with the rotation of the at least one second blade;
the feeder being configured to controllably direct a material into the overlapping portion of the at least one first blade and the at least one second blade to produce shredded material segments, the segments measuring less than a predetermined size in any direction.

2. The shredding device of claim 1 wherein the material is gypsum board.

3. The shredding device of claim 1 wherein the at least one first blade and the at least one second blade have a blade density of from about 0.50 to about 0.65.

4. The shredding device of claim 1 wherein the at least one first blade and the at least one second blade rotate in opposite directions.

5. The shredding device of claim 1 wherein the material has a thickness of up about 2 inches.

6. The shredding device of claim 1 wherein the predetermined size is about ½ inch or less.

7. The shredding device of claim 1 wherein the at least one first blade and the at least one second blade have a gullet disposed adjacent a base of a corresponding cutting surface of the first cutting area of the at least one first blade and the second cutting area of the at least one second blade, the gullet defining an open geometric profile between about 80 percent and about 90 percent the corresponding cutting surface of the first cutting area of the at least one first blade and the second cutting area of the at least one second blade.

8. The shredding device of claim 1 wherein the overlapping portion between the at least one first blade and the at least one second blade being greater than a thickness of the material.

9. The shredding device of claim 1 wherein the overlapping portion between the at least one first blade and the at least one second blade being greater than a thickness of the material and the at least one first blade and the at least one second blade each having a protrusion extending past a surface of the material opposite each of the at least one first blade and the at least one second blade.

10. The shredding device of claim 1 further comprising:
a conveyor having a first end and a second end, the first end of the conveyor disposed adjacent to the at least one first blade and the at least one second blade to receive and transport shredded material segments from the at least one first blade and the at least one second blade; and
an enclosure disposed adjacent the second end of the conveyor to receive the shredded material segments from the conveyor.

11. The shredding device of claim 1 wherein the at least one first blade is a plurality of first blades, the at least one second blade is a plurality of second blades, and the first cutting area of the plurality of first blades and the second cutting area of the plurality of second blades overlap and mesh with each other.

12. The shredding device of claim 1 wherein at least one of the first cutting area of the at least one first blade and the second cutting area of the at least one second blade is configured to have a negative hook angle.

13. The shredding device of claim 12 wherein the negative hook angle is between about 45 degrees and about 80 degrees.

14. The shredding device of claim 13 wherein the negative hook angle is about 60 degrees.

15. A method for shredding a material with a shredding device for producing shredded material segments, the shredding device including a feeder, at least one first blade, at least one second blade rotatably associated with the at least one first blade, the at least one first blade and the at least one second blade having an overlap, the method comprising:
rotating the at least one first blade and the at least one second blade;
directing the material into the overlap for producing shredded material segments;
forming a plurality of blade cutting surfaces having a negative hook angle of at least about 45 degrees on at least one of the at least one first blade or the at least one second blade so as to produce non-strip material segments measuring less than a predetermined size in any direction.

16. The method of claim 15 wherein the negative hook angle is between about 45 degrees and about 80 degrees.

17. The method of claim 16 wherein the negative hook angle is about 60 degrees.

18. The method of claim 15 wherein the predetermined size is about ½ inch or less.

19. The method of claim 15 wherein the step of directing the material further includes directing the material into the overlap so that each of the at least one first blade and the at least one second blade cut through the entire thickness of the material and containing a protrusion past a surface of the material that is furthest from each of the at least one first blade and the at least one second blade.

20. The method of claim 19 further comprising the steps of:
conveying the shredded material segments to a location away from the at least one first blade and the at least one second blade; and
depositing the shredded material segments at the location, the location being surrounded by an enclosure.

21. A shredding device comprising:
a feeder;
a plurality of first blades;
a plurality of second blades interposed between the plurality of first blades and rotatably associated with the plurality of first blades, the plurality of first blades and the plurality of second blades having an overlap and intermeshing, wherein at least one of the plurality of first blades and at least one of the plurality of second blades has a negative hook angle of at least about 45 degrees, wherein upon the material being directed into the overlap, each of the plurality of first blades and the plurality of second blades cutting through the entire thickness of the material and containing a protrusion past a surface of the material that is furthest from each of the at least one first blade and the at least one second blade;
means for rotating the at least one first blade and the at least one second blade wherein rotation of the at least one first blade does not interfere with the rotation of the at least one second blade;
the feeder controllably directing a material into the overlap for producing non-strip shredded material segments, the segments measuring less than a predetermined size in any direction;
a conveyor having a first end and a second end, the first end of the conveyor disposed adjacent to the at least one first blade and the at least one second blade for transporting shredded material segments to a location away from the at least one first blade and the at least one second blade; and
an enclosure disposed adjacent the second end of the conveyor, the enclosure surrounding the location receiving the shredded material segments from the conveyor.
